(19) United States
(12) Patent Application Publication
(10) Pub. No.: US 2007/0020043 A1
(43) Pub. Date: Jan. 25, 2007

(54) Connecting structure for connecting together rotation operation shaft and operation knob of electric apparatus

(75) Inventor: Yoshiyuki Okada, Osaka (JP)

Correspondence Address: OSHA LIANG L.L.P., 1221 MCKINNEY STREET, SUITE 2800, HOUSTON, TX, 77010, US

(73) Assignee: Funai Electric Co., Ltd., Daito-shi (JP)

(21) Appl. No.: 11/484,843

(22) Filed: Jul. 11, 2006

(30) Foreign Application Priority Data
Jul. 11, 2005 (JP) P2005-201260

(51) Int. Cl. B25G 3/20; F16B 2/00

(52) U.S. Cl. 403/371

(57) ABSTRACT

A connecting structure includes: a cylindrical part formed in a rotation operation shaft; a shaft part formed in an operation knob; and division grooves respectively extending in the axial direction of the cylindrical part, wherein: the cylindrical part and a shaft part are tight fit connected together; in two or more portions of the cylindrical part at equal angle intervals in the peripheral direction thereof, there are formed the division grooves, thereby being able to enhance the flexural deformation property of the cylindrical part as well as to secure mutual concentricity between the cylindrical part and the shaft part formed of resin; and at least one of the division grooves is used as a key groove with which is fitted a key portion formed in the outer peripheral portion of the shaft part, thereby preventing the cylindrical and shaft parts from rotating with respect to each other.

### BACKGROUND

1. Technical Field

The present invention relates to a connecting structure for connecting together the rotation operation shaft and operation knob of an electric apparatus such as a projector and, more specifically, the invention relates to a connecting structure for connecting together the rotation operation shaft and operation knob of an electric apparatus, the connecting structure being arranged such that the resin-made shaft part of the operation knob is tight fit connected with the resin-made cylindrical part of the rotation operation shaft.

2. Related Art

Conventionally, in a scanner, there are known a technique in which a shaft and a mounting tool are assembled together by means of shrinkage fit to thereby secure precision (for example, see JP-A-2003-161905); a technique in which, when the rotation hub of a motor is mounted onto a shaft by means of tight fit, a lubricant is interposed between the fitting portions of the rotation hub and shaft (for example, see JP-A-2003-165032); a technique in which, in order to positively match the facet of a rotation optical scanning wheel to its rotation axis, the inner hole of the rotation optical scanning wheel is worked with high precision to thereby bring it tight fit engagement with shaft bearing means (for example, see JP-A-6-235875); a technique in which, after a shaft is inserted into a sleeve with its inside diameter enlarged due to the action of a high pressure fluid, the high pressure fluid is removed to thereby allow the sleeve to tighten the shaft (for example, see Patent Reference 4); and, other similar techniques.

Here, when two parts respectively made of resin moldings are fitted and connected with each other, as a measure for securing a good assembling condition with respect to other parts, in some cases, there is employed a technique in which the two parts are connected together by means of tight fit and, by making good use of the properties of the tight fit connected portions thereof, a fit allowance between the two parts is adjusted, that is, increased or decreased. For example, when the shaft part of a hand-operated operation knob employed in an electric apparatus such as a projector is connected with the cylindrical part of a rotation operation shaft, if there are found variations in the mutual position precision between the rotation operation shaft and the box body of the electric apparatus, in some cases, there is employed a technique in which the fit allowance between the shaft part and cylindrical part connected together through tight fit is adjusted increasingly or decreasingly to thereby absorb such variations in the position precision.

In such connecting structure for connecting together two parts through tight fit, in other words, in the connecting structure for connecting together the above-mentioned shaft part and cylindrical part, when the cylindrical part is formed in a closed cylindrical shape, the tightening degree thereof must be determined only depending on the flexural deformation property of the material itself of the cylindrical portion and, therefore, high dimensional precision is required of both of the cylindrical and shaft parts. This raises a problem that it is indispensable to employ a high level technique for producing the cylindrical and shaft parts.

### SUMMARY

Thus, as a measure against the above-mentioned problem, there has been made an attempt in which a notch-like division groove is formed at an arbitrary portion in the peripheral direction of the cylindrical part to thereby enhance the flexural deformation property of the cylindrical part. However, in this attempt, there has been found the following fact. That is, there occurs a case where the cylindrical part and shaft part tight fit engaged with the cylindrical part are connected together while they are inclined. If they are connected together while inclined, in the above-mentioned projector, the operation knob having such shaft part is inclined with respect to the box body of the electric apparatus, which worsens the external appearance of the connecting structure and impairs the operation performance thereof.

The present invention has been made in view of the above-mentioned problems and circumstances. Thus, it is an object of the invention to provide a connecting structure for connecting together the rotation operation shaft and operation knob of the electric apparatus, the connecting structure being arranged such that, when division grooves are formed in the cylindrical part of the rotation operation shaft to thereby enhance the flexural deformation property of the cylindrical part, there are taken measures capable of balancing the flexural deformation properties of the respective portions of the cylindrical part in the peripheral direction thereof with each other, thereby preventing the tight fit engaged portions between the cylindrical part of the rotation operation shaft and the shaft part of the operation knob from being out of concentricity with respect to each other; and also, when enhancement in the flexural deformation property of the cylindrical portion is attained, it is possible to positively prevent the occurrence of a situation that, the cylindrical and shaft parts are easy to idle with respect to each other.

A connecting structure for connecting together the rotation operation shaft and operation knob of an electric apparatus according to the invention is a connecting structure for connecting together the rotation operation shaft and operation knob of an electric apparatus, which is arranged such that a cylindrical part formed in the rotation operation shaft and a shaft part formed in the operation knob are connected together in a tight fit manner to thereby be able to adjust a fit allowance between them increasingly or decreasingly, wherein division grooves respectively extending in the axial direction of the cylindrical part formed of resin are formed in two or more portions of the cylindrical part at equal angle intervals in the peripheral direction of the cylindrical part to thereby be able to not only enhance the flexural deforming property of the cylindrical part but also secure the mutual concentricity between the cylindrical part and the shaft part formed of resin; and also wherein at least one of the division grooves is used as a key groove with which is fitted a key portion formed in the outer peripheral portion of the shaft part to thereby be able to prevent the cylindrical and shaft parts from rotating with respect to each other.

According this structure, the formation of the division grooves in two or more portions of the cylindrical part can enhance the flexural deformation property of the cylindrical part as well as, owing to the fact that the division grooves are formed in two or more portions of the cylindrical part at equal angle intervals in the peripheral direction of the cylindrical part, the flexural deformation properties of the respective portions of the cylindrical part in the peripheral direction thereof are allowed to balance out. This can prevent the occurrence of a situation that the cylindrical part and the shaft part tight fit engaged with the cylindrical part are out of concentricity with respect each other and are thereby inclined with respect to each other. Also, since at least one of the division grooves is used as a key groove with which is fitted a key portion formed in the outer peripheral portion of the shaft part, the cylindrical part and shaft part are prevented from rotating with respect to each other, thereby being able to prevent them from idling with respect to each other.

According to the invention, by setting even the thicknesses of two or more arbitrary portions of the cylindrical wall of the cylindrical part in the peripheral direction thereof, it is possible to employ a structure that the elastic constants of the respective cylindrical wall pieces divided and formed by the division grooves are set even; and, employment of this structure can make it easy for the flexural deformation properties of the respective portions of the cylindrical part in the peripheral direction thereof to balance out.

According to the invention, it is possible to employ a structure in which the above-mentioned division grooves are formed in four portions of the cylindrical part at equal angle intervals in the peripheral direction thereof and one of the division grooves is used as a key groove with which is fitted a key portion formed in one portion of the outer peripheral portion of the shaft part. According to this structure, the lowered strength of the cylindrical part caused by the formation of the division grooves is not so great. Thanks to this, the rotational movement of the operation knob manually operated can be positively transmitted to the rotation operation shaft through the tight fit engaged portions between the shaft part and cylindrical part.

A connecting structure for connecting together the rotation operation shaft and operation knob of an electric apparatus according to the invention can be embodied more advantageously by employing a connecting structure for connecting together the rotation operation shaft and operation knob of en electric apparatus, which is arranged such that a cylindrical part formed in the rotation operation shaft and a shaft part formed in the operation knob are tight fit connected together to thereby be able to increasingly or decreasingly adjust a fit allowance between them, wherein, in four portions of the resin-molded cylindrical part at equal angle intervals in the peripheral direction thereof, there are formed division grooves respectively extending in the axial direction of the cylindrical part, thereby being able to enhance the flexural deformation property of the cylindrical part as well as to secure mutual concentricity between the cylindrical part and the shaft part formed of resin, and one of the division grooves is used as a key groove with which is fitted a key portion formed in the outer peripheral portion of the shaft part, thereby preventing the cylindrical and shaft parts from rotating with respect to each other; and also wherein a fit allowance between the cylindrical and shaft parts can be adjusted increasingly or decreasingly to thereby be able to adjust the height position of the operation knob with respect to the top plate portion of the box body of an electric apparatus composed of a projector and, integrally with the rotation operation shaft, there is formed a resin-made pinion for operating the zoom adjusting mechanism of the projector. The operation of the invention will be described in detail with reference to an embodiment of the invention to be discussed later.

As described above, according to the invention, not only the flexural deformation properties of the respective portions of the cylindrical part in the peripheral direction thereof balance out to thereby make it difficult for the tight fit engaged portions between the cylindrical and shaft parts to be out of concentricity, but also, when the flexural deformation property of the cylindrical part is enhanced, it is possible to positively prevent the occurrence of a situation that the cylindrical and shaft parts are easy to idle with respect to each other. Therefore, even when the fit allowances of the two parts are adjusted increasingly or decreasingly in the connected portions between the cylindrical and shaft parts connected together in a tight fit manner to thereby absorb variations in the mounting precision of the rotation operation shaft, the operation knob is prevented from being inclined so that the operation efficiency of the operation knob can be kept well. Also, the mutual position precision between the operation knob and the box body of the electric apparatus can be kept in a proper level. Further, according to the invention, since it is possible to employ the simple structure in which the division grooves are formed in the cylindrical part and the key portion is formed in the shaft part, the invention is advantageous in mass production and also can prevent an increase in the number of parts to thereby prevent the assembling efficiency of the invention from being impaired.

### BRIEF DESCRIPTION OF THE DRAWINGS

These and other objects and advantages of this invention will become more fully apparent from the following detailed description taken with the accompanying drawings in which:

FIG. 1 is a schematic perspective external view of a projector used as an electric apparatus to which the invention is applied;

FIG. 2 is a schematic section view of the main portions of the projector;

FIG. 3A is a plan view of a zoom adjusting operation knob including a resin-formed shaft part, when it is viewed from below, and

FIG. 3B is a side view of the same operation knob;

FIG. 4A is a plan view of a cylindrical part including a pinion formed integral therewith, and

FIG. 4B is a side view of the same cylindrical part;

FIG. 5 is a partially broken side view of a vertical shaft; and

FIG. 6 is an enlarged transverse sectional plan view of the same vertical shaft.

### DETAILED DESCRIPTION

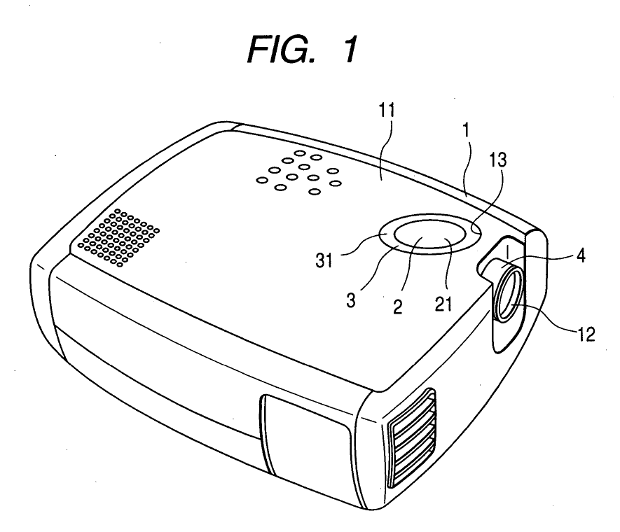

Now, FIG. 1 is a schematic perspective external view of a projector used as an electric apparatus to which the invention is applied. In this projector, a box body 1 is divided into a bottom case, a top case, a front case and the like which are connected to each other. In the front surface of the box body 1, there are formed a projection opening 12 and the like; and, in a circular opening 13 formed in a portion of a top plate portion 11 of the box body 1, there are arranged a disk-shaped zoom adjusting operation knob 2 and a ring-shaped focus adjusting operation knob 3 which are set concentric with each other. Also, the operation surfaces 21, 31 of the respective operation knobs 2, 3 are generally exposed to the outside of the box body 1 in such a manner that they are not projecting out from the top surface of the box body 1 so much, that is, they are positioned flush with or substantially flush with the top surface of the box body 1.

The respective operation knobs 2, 3 are disposed in the opening 13 of the box body 1 instead of arranging a zoom adjusting ring and a focus adjusting ring in the periphery of a lens barrel 4. And, the operation knobs 2, 3 can be manually operated or rotated individually about their respective longitudinal axes. When operating the zoom adjusting knob 2, it may be rotated in such a state that a finger of an operator is pressed against the circular-shaped operation surface 21 thereof; and, when operating the focus adjusting knob 3, it may be rotated with the finger pressed against the ring-shaped operation surface 31 thereof. Therefore, the arrangement of the respective operation knobs 2, 3 in the opening of the top surface of the box body 1 is useful in improving the operation efficiency of the operation knobs 2, 3.

In this projector, by manually operating and rotating the zoom adjusting operation knob 2, the size of a projection image to be projected on a screen disposed forwardly of the projection opening 12 formed by the lens barrel 4 can be corrected; and, by manually operating and rotating the focus adjusting operation knob 3, the quality (focus quality) of a projection image to be projected on the screen can be corrected. Such manual rotational operations of the respective knobs 2, 3 are operations to be carried out by an operator while pressing his or her finger against the operation surfaces 21, 31 of the respective knobs 2, 3.

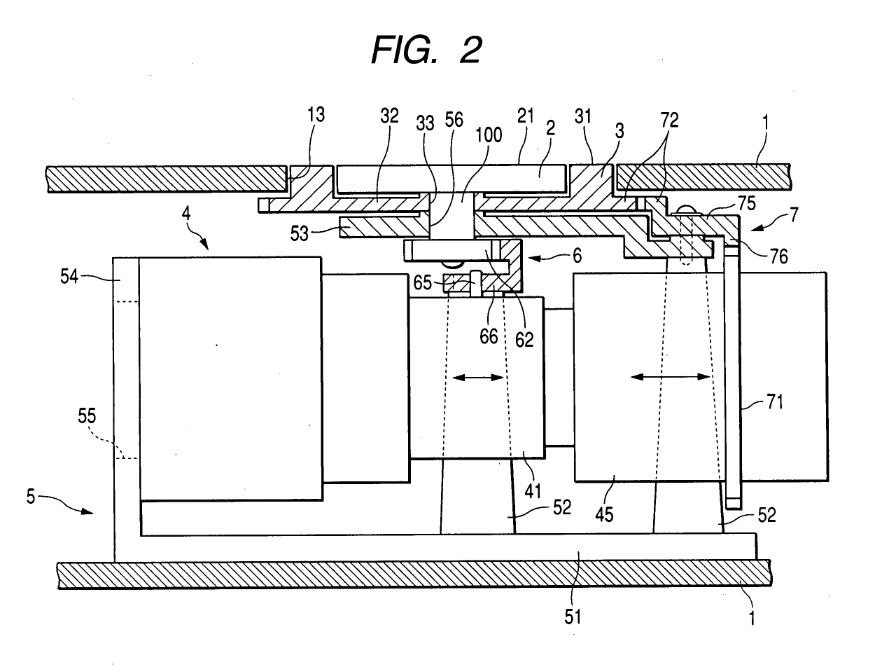

Now, FIG. 2 is a schematic section view of the main portions of the projector. In FIG. 2, a reference numeral 5 designates a structure body. The lens barrel 4 is mounted on a mounting plate 54 erected from the bottom plate of the structure body 5, while, in the mounting plate 54, there is formed a light intake opening 55. Also, on a support plate 53 fixedly secured to the post 52 of the structure body 5, there is arranged a disk-shaped base portion 32 formed in the focus adjusting operation knob 3. And, there is disposed a vertical shaft 100 which penetrates through an axial hole 33 formed in the base portion 32 and a bearing hole 56 formed in the support plate 53 and connects the zoom adjusting operation knob 2 with a pinion 62, whereby the respective operation knobs 2, 3 can be rotated around their respective longitudinal axes individually.

In the lens barrel 4, there are included a zoom adjusting member 41 which can be guided by a guide (not shown) and can be advanced and retreated in the back-and-forth direction of the lens barrel 4, and a focus adjusting member 45 which can be similarly guided by another guide and can be advanced and retreated in the back-and-forth direction. Thus, the zoom adjustment can be made through the back-and-forth-direction advancing and retreating operations of the zoom adjusting member 41, while the focus adjustment can be made through the back-and-forth-direction advancing and retreating operations of the focus adjusting member 45. And, the zoom adjusting operation knob 2 and zoom adjusting member 41 are connected with each other by a zoom adjusting mechanism 6, whereas the focus adjusting knob 3 and focus adjusting member 45 are connected together by a focus adjusting mechanism 7.

The zoom adjusting mechanism 6 includes a rack 61 meshingly engaged with the pinion 62, a pin-shaped movable body 65 provided on the zoom adjusting member 41, and a slide cam 66 for advancing and retreating in the back-and-forth direction through its horizontal movement.

The focus adjusting mechanism 7 includes: a gear 71 which is formed in the focus adjusting member 45 and, when it is rotated, allows the focus adjusting member 45 to advance and retreat in the back-and-forth direction; a pinion rack mechanism 72 for converting a rotation movement to a linear movement; and, a slider 75 including a rack 76 which is formed integrally therewith and is meshingly engaged with the gear 71.

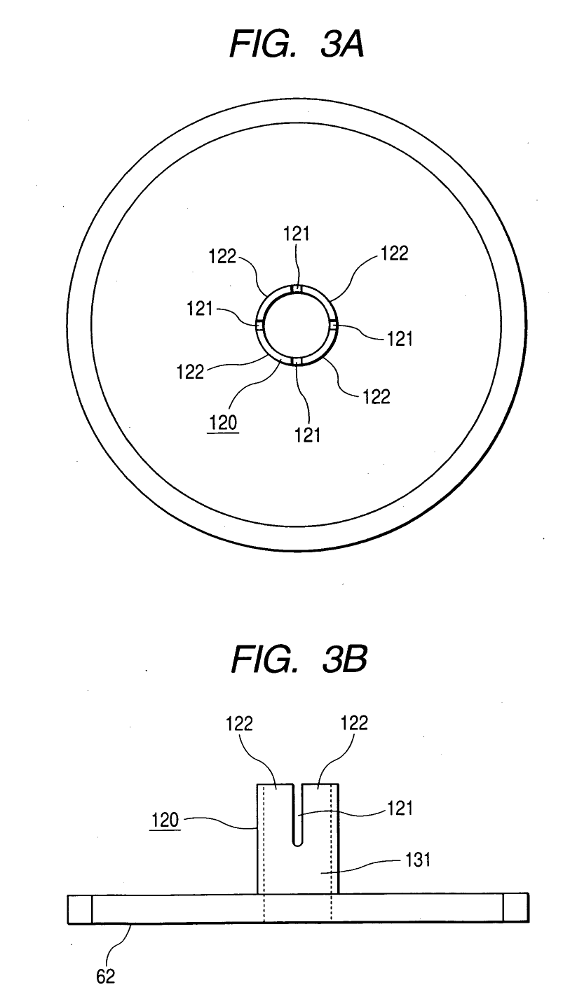

In the projector having the above-mentioned structure, the present invention is applied to the vertical shaft 100 which has been described with respect to FIG. 2 and connects together the zoom adjusting operation knob 2 and pinion 62. Now, description will be given below of this connection with reference to FIGS. 3A to 6.

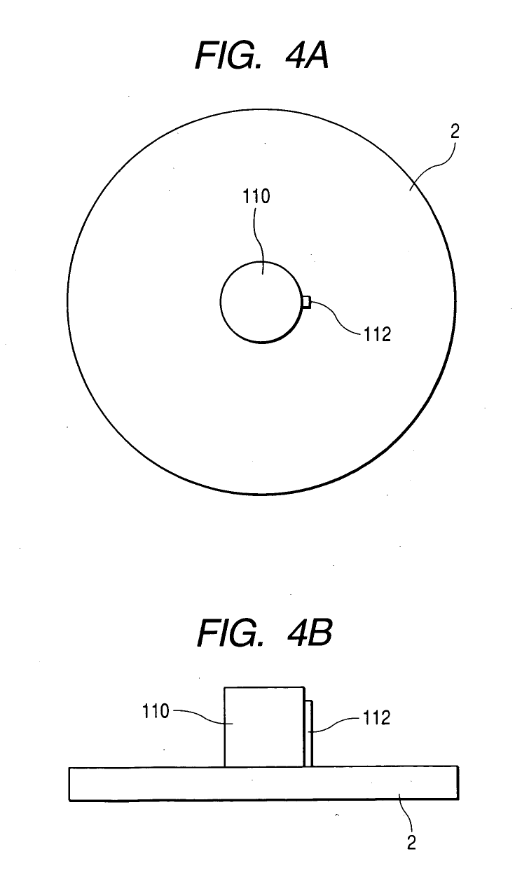

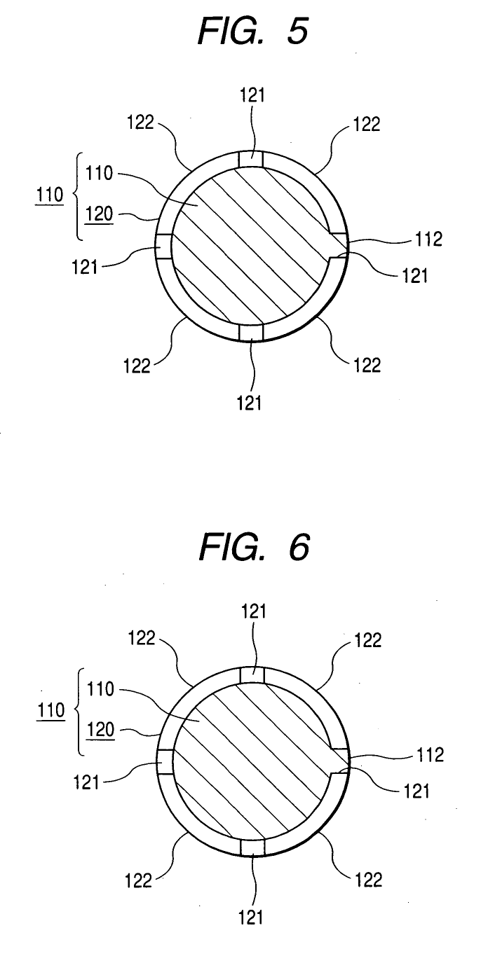

Now, FIG. 3 A is a plan view of a zoom adjusting operation knob 2 including a resin-molded shaft portion 100, when it is viewed from below, FIG. 3B is a side view of the operation knob 2, FIG. 4A is a plan view of a cylindrical part 120 with which the pinion 62 is formed integrally, FIG. 4B is a side view of the cylindrical part 120, FIG. 5 is a partially broken side view of a vertical shaft 100, and FIG. 6 is an enlarged transverse sectional plan view of the vertical shaft 100.

As shown in FIG. 5 or FIG. 6, the vertical shaft 100 is structured such that a solid shaft part 110 resin molded integrally with the zoom adjusting operation knob 2 is tight fit connected with the cylindrical part 120 which is integrally formed with the pinion 62 and is formed by the whole of a resin-made rotation operation shaft 130.

As shown in FIGS. 3A and 3B, in the cylindrical part 120 of the rotation operation shaft 130, there are formed four axially-extending division grooves 121 in four portions of the cylindrical portion 120 at equal angle intervals (in an example shown in FIGS. 3A and 3B, at every 90-degree intervals) in the peripheral direction of the cylindrical wall thereof to thereby enhance the flexural deformation property of the cylindrical part 120; and at the same time, the thicknesses of two or more arbitrary portions of the cylindrical part 120 in the peripheral direction of the cylindrical wall thereof are set even to thereby set even the elastic constants of the respective cylindrical wall pieces 122 divisionally formed by the division grooves 121, whereby the flexural deformation properties of the respective portions of the cylindrical part 120 in the peripheral direction thereof are made to balance out. Therefore, as shown in FIG. 5 or FIG. 6, in a state where the shaft part 110 is tight fit engaged with such cylindrical part 120, the concentricity of the cylindrical portion 120 and shaft portion 110 can be secured, which makes it difficult to cause a situation that these two parts can be out of concentricity and can be thereby inclined with respect to each other.

Also, the division groove 121 formed in one portion of the cylindrical part 120 is used as a key groove with which is engaged a key portion 112 formed in one portion of the outer peripheral portion of the shaft part 110, thereby preventing the cylindrical part 120 and shaft part 110 from rotating with respect to each other. Therefore, when the zoom adjusting operation knob 2 is manually operated or rotated, the rotational movement of the operation knob 2 can be positively transmitted to the pinion 62 through the shaft part 110 and cylindrical part 120, thereby being able to positively prevent the two parts from idling with respect to each other.

Further, even when a fit allowance in the connecting portion of the cylindrical part 120 and shaft part 110 engaged together by tight fit is adjusted increasingly or decreasingly to thereby absorb variations in the mounting precision of the rotation operation shaft 130 with respect to the box body 1 (see FIG. 1 or FIG. 2), the zoom adjusting operation knob 2 is prevented from being inclined so that the operation performance of the knob 2 can be kept excellent. In addition to this, the position precision between the zoom adjusting operation knob 2 and box body 1 can be kept proper and thus the surface of the operation knob 2 can be easily made flush with the surface of the box body 1.

In the present embodiment, the division grooves 121 are formed in four portions of the cylindrical part 120; however, the division grooves may be formed in three or two positions of the cylindrical port 120 at equal peripheral-direction angle intervals. Also, two or all of the division grooves 121 may be used as key grooves.

What is claimed is:

1. A connecting structure for connecting a rotation operation shaft and an operation knob of an electric apparatus, the connecting structure comprising:
a cylindrical part formed in the rotation operation shaft;
a shaft part formed in the operation knob; and
division grooves respectively extending in the axial direction of the cylindrical part, wherein:
the cylindrical part and the shaft part are tight fit connected together to thereby be able to increasingly or decreasingly adjust a fit allowance between them;
in four portions of the cylindrical part formed of resin at equal angle intervals in the peripheral direction thereof, there are formed the division grooves, thereby being able to enhance the flexural deformation property of the cylindrical part as well as to secure mutual concentricity between the cylindrical part and the shaft part formed of resin;
one of the division grooves is used as a key groove with which is fitted a key portion formed in the outer peripheral portion of the shaft part, thereby preventing the cylindrical and shaft parts from rotating with respect to each other; and
a fit allowance between the cylindrical and shaft parts can be adjusted increasingly or decreasingly to thereby be able to adjust the height position of the operation knob with respect to the top plate portion of the box body of the electric apparatus composed of a projector and, integrally with the rotation operation shaft, there is formed a resin-made pinion for operating the zoom adjusting mechanism of the projector.

2. A connecting structure for connecting a rotation operation shaft and an operation knob of an electric apparatus, the connecting structure comprising:
a cylindrical part formed in the rotation operation shaft;
a shaft part formed in the operation knob; and
division grooves respectively extending in the axial direction of the cylindrical part, wherein:
the cylindrical part and a shaft part are tight fit connected together to thereby be able to increasingly or decreasingly adjust a fit allowance between them;
in two or more portions of the cylindrical part formed of resin at equal angle intervals in the peripheral direction thereof, there are formed the division grooves, thereby being able to enhance the flexural deformation property of the cylindrical part as well as to secure mutual concentricity between the cylindrical part and the shaft part formed of resin; and
at least one of the division grooves is used as a key groove with which is fitted a key portion formed in the outer peripheral portion of the shaft part, thereby preventing the cylindrical and shaft parts from rotating with respect to each other.

3. The connecting structure according to claim 2, wherein
the thicknesses of two or more arbitrary portions of the cylindrical wall of the cylindrical part in the peripheral direction thereof are set even to thereby set even the elastic constants of the respective cylindrical wall pieces respectively divided and formed by the division grooves.

4. The connecting structure according to claim 2, wherein
the division grooves are formed in four portions of the cylindrical part at equal angle intervals in the peripheral direction thereof and one of the division grooves is used as a key groove with which is fitted a key portion formed in one portion of the outer peripheral portion of the shaft part.
